(19) United States
(12) Patent Application Publication
(10) Pub. No.: US 2016/0075044 A1
(43) Pub. Date: Mar. 17, 2016

(54) SLICER

(71) Applicant: BENRINER CO., LTD, Yamaguchi (JP)

(72) Inventor: Hajime YAMAMOTO, Yamaguchi (JP)

(21) Appl. No.: 14/548,031

(22) Filed: Nov. 19, 2014

(30) Foreign Application Priority Data
Sep. 12, 2014 (JP) 2014-186317

(51) Int. Cl. B26D 3/28

(52) U.S. Cl. CPC B26D 3/283

(57) ABSTRACT

A slicer that can be used safely without causing a slip even when it is used with its tip end being pressed onto a chopping board. A slicer 1 provided with a frame 10 having a pair of supporting arms 11, and a slicing blade 20 with its two ends being supported by the paired supporting arms 11, so that by reciprocally moving a material to be sliced in a slicing direction S toward the slicing blade 20, the material to be sliced is sliced, and in this structure, an anti-slipping member 100, which is disposed under the frame 10 at a tip end thereof in the slicing direction S, with an elastomer resin being expanded on its surface, is further prepared.

### BACKGROUND OF THE INVENTION

1. Field of the Invention

The present invention relates to a slicer for slicing a material to be sliced, such as a vegetable, fruit or the like, and in particular concerns a slicer in which the slice width of the material to be sliced is desirably adjustable.

2. Description of the Related Art

Conventionally, as a slicer for use in easily slicing various materials to be sliced, such as vegetables, fruits or the like, into sliced pieces having a desired width, such a slicer has been used in which the material to be sliced is reciprocally moved forward and rearward in the slicing direction so as to slice the material to be sliced by using a slicing blade.

As a conventional slicer, such a slicer has been known which is provided with a frame having a pair of right and left supporting arms, a slicing blade the two ends of which are fixed to the supporting arms, a fixed supporting plate that is disposed on the front side of the slicing blade and passed between a pair of right and left frame portions and a movable supporting plate that is disposed on the rear side of the slicing blade so that by moving the movable supporting plate in the vertical direction, the slice width (thickness), that is, the sliced width of the material to be sliced, can be adjusted.

With respect to the movable supporting plate of this slicer, a structure has been known (for example, see JP-A No. 2004-338069) in which the plate has its two ends journaled onto a pair of right and left supporting arms so as to be reciprocally movable in the vertical direction, and another structure has been known (for example, see JP-A No. 2011-156435) in which the plate can be shifted horizontally in the vertical direction by a spacer disposed below a movable receiving plate. These slicers may be used in a state where the material to be sliced is sliced with the slicer being kept in parallel therewith, and in another state where the material to be sliced is sliced in a tilted attitude with the tip of the slicer being made in contact with a chopping board or the top plate of a table (hereinafter, referred to as “chopping board or the like”).

[Patent Document 1] JP-A No. 2004-338069

[Patent Document 2] JP-A No. 2011-156435

In the case when the material to be sliced is sliced with the above-mentioned slicer being tilted relative to the chopping board or the like, a pressing force exerted on the slicer is concentrated onto a contact portion between the slicer and the chopping board or the like, that is, onto the tip of the slicer, and since the slicer tends to easily slip on the chopping board or the like, it is difficult to maintain the tilted attitude of the slicer, causing a problem, such as a failure in slicing the material to be sliced into a desired thickness, and another problem that the user might get injured in his or her finger with the slicing blade because of the slippery slicer.

For this reason, technical problems are raised in an attempt to provide a slicer that can be used safely even when used in a tilted attitude, with the tip thereof being pushed against the chopping board or the like, and the object of the present invention is to solve these problems.

### SUMMARY OF THE INVENTION

The present invention, which has been proposed to achieve the above object, includes an invention according to one embodiment that provides a slicer having: a frame having a pair of supporting arms; and a slicing blade with two ends thereof being supported by the paired supporting arms, so that by reciprocally moving a material to be sliced in a slicing direction toward the slicing blade, the material to be sliced is sliced, and in this structure an anti-slipping member, which is disposed under the frame at a tip end thereof in the slicing direction, is further prepared.

In accordance with this structure, even in the case when a material to be sliced is sliced, with the slicer being diagonally secured onto a chopping board or the like, since an elastomer resin of the anti-slipping member is made in contact with the chopping board or the like, the frictional resistance between the slicer and the chopping board or the like increases. Thus, it is possible to prevent so-called slipping, that is, a phenomenon in which the slicer slips on the chopping board or the like by a force exerted upon reciprocally moving the material to be sliced in the slicing direction, and the attitude of the slicer can be maintained.

An invention disclosed in another embodiment provides a slicer in which, in addition to the structure of the slicer of one embodiment, the anti-slipping member is further provided with: a base portion that is disposed on a rear surface of the frame and made of polypropylene; and an elastomer portion formed by fixing an elastomer resin on the surface of the base portion.

In accordance with this structure, by laminating the elastic elastomer portion on the base portion made of polypropylene that is harder than the elastomer portion, it is possible to prevent the anti-slipping member from being undesirably deformed and consequently to increase the frictional resistance between the anti-slipping member and the chopping board or the like, even when a pressing force is exerted onto the anti-slipping member upon slicing the material to be sliced; therefore, the anti-slipping member can positively support the slicer and the slipping of the slicer can be suppressed.

An invention disclosed in another embodiment provides a slicer in which, in addition to the structure of the slicer of one embodiment, the elastomer portion is formed by spraying the elastomer resin onto the surface of the base portion.

In accordance with this structure, since the elastomer portion is uniformly formed on the surface of the base portion, the frictional resistance between the slicer and the chopping board or the like is increased without deviations so that it becomes possible to further suppress the slipping of the slicer.

An invention disclosed in another embodiment provides a slicer in which in addition to the structure described in the other embodiments, the elastomer portion is formed over the entire surface of the base portion.

In accordance with this structure, since the contact area between the elastomer portion and the chopping board or the like is ensured and since the frictional resistance between the slicer and the chopping board or the like is further increased, it is possible to further suppress the slipping of the slicer.

An invention disclosed in another embodiment provides a slicer in which in addition to the structure described in any one of the other embodiments, the elastomer portion is formed into a curved convex shape with the surface thereof facing the outside.

In accordance with this structure, since the elastomer portion that is formed into the convex shape with the surface thereof facing the outside is positively made in contact with the chopping board or the like regardless of the tilted angle of the slicer, it is possible to further suppress the slipping of the slicer.

### Effects of the Invention

In the slicer in accordance with the present invention, since the anti-slipping member increases the frictional resistance exerted between the slicer and the chopping board or the like, it is possible to use the slicer safely, even in the case when the material to be sliced is sliced with the slicer being tilted relative to the chopping board or the like.

### BRIEF DESCRIPTION OF THE DRAWINGS

FIGS. 1A and 1B are views showing a slicer in accordance with one embodiment of the present invention; FIG. 1A is a perspective view showing the surface side of the slicer; and FIG. 1B is a perspective view showing the rear surface side of the slicer.

FIGS. 2A, 2B and 2C are views showing a frame and a fixed supporting plate of FIG. 1; FIG. 2A is a plan view of a frame; FIG. 2B is a bottom face view of the frame; and FIG. 2C is a cross-sectional view taken along line A-A of FIG. 2A.

FIGS. 3A to 3D are views showing a movable supporting plate of FIG. 1; FIG. 3A is a plan view; FIG. 3B is a bottom face view; FIG. 3C a side face view; and FIG. 3D is a cross-sectional view taken along line B-B of FIG. 3A.

FIGS. 4A, 4B, and 4C are views showing a slice width adjusting dial of FIG. 1; FIG. 4A is a perspective view showing the slice width adjusting dial; FIG. 4B is a plan view of the slice width adjusting dial; and FIG. 4C is a cross-sectional view taken along line C-C of Fig. FIG. 4B.

FIG. 5 is a perspective view showing an anti-slipping member.

FIGS. 6A to 6E are views showing an anti-slipping member; FIG. 6A is a front view; FIG. 6B is a back face view; FIG. 6C is a side view; FIG. 6D is a cross-sectional view taken along line D-D of FIG. 6A; and FIG. 6E is a cross-sectional view taken along line E-E of FIG. 6A.

FIG. 7 is a partially enlarged view of an F portion of FIG. 6D.

### DETAILED DESCRIPTION OF THE PREFERRED EMBODIMENTS

In order to achieve the object of the present invention for providing a slicer that can be used safely even in the case when it is used in a tilted attitude with its tip being pressed onto a chopping board or the like, a slicer of the present invention, which is provided with a frame having a pair of supporting arms and a slicing blade having two ends supported by the paired supporting arms, and is used for slicing a material to be sliced by reciprocally sliding and moving the material to be sliced in a slicing direction toward the slicing blade, is further provided with an anti-slipping member that is disposed under the frame at the tip in the slicing direction; thus, the object of the invention is achieved.

Referring to Figs., the following description will discuss a slicer 1 relating to one embodiment in accordance with the present invention. Additionally, in the following description, terms “front” and “rear” correspond to the front side and the rear side in a slicing direction that is coincident with a feeding direction of a material to be sliced at the time of slicing the material to be sliced. Moreover, terms “up” and “down” correspond to the upper side and the downward side in a direction perpendicular to the slicer.

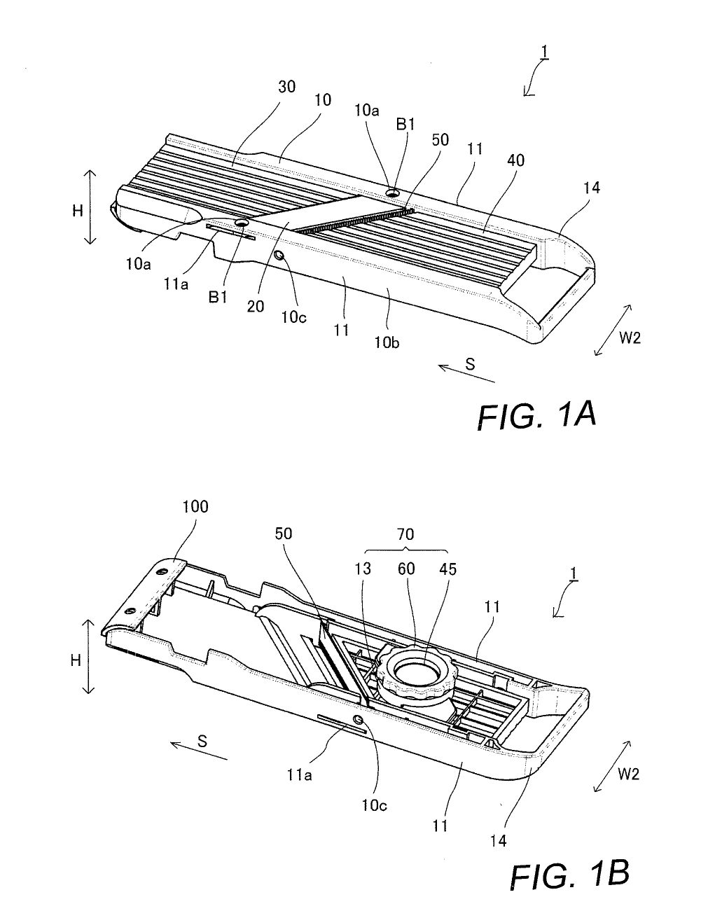

As shown in FIGS. 1A and 1B, the slicer 1 is provided with a frame 10, a slicing blade 20 for slicing the material to be sliced, a fixed supporting plate 30 disposed on the front side of the slicing blade 20, a movable supporting plate 40 that is disposed on the rear side of the slicing blade 20, an exchange blade 50 that is exchangeable, and a slice width adjusting mechanism 70 for use in position-determining the movable supporting plate 40 at a desired position in the vertical direction by using a slice width adjusting dial 60. The frame 10, the fixed supporting plate 30, the movable supporting plate 40 and the slice width adjusting dial 60 are respectively made of ABS resin, and produced by an injection molding process. The slicing blade 20 and the exchange blade 50 are made of stainless steel.

The slicer 1 is designed such that when a user reciprocally moves a material to be sliced in a slicing direction S while pressing the material to be sliced onto the movable supporting plate 40, the material to be sliced is sliced into sliced pieces having a thickness in accordance with a gap between the slicing blade 20 and the movable supporting plate 40. The sliced pieces are discharged from the rear side of the slicer 1.

The slicing blade 20 is extended diagonally relative to a width direction W1 of the frame 10. On the right and left sides of the slicing blade 20, holes not shown, are respectively formed. The slicing blade 20 is fastened to the frame 10 by bolts B1 inserted through attaching holes 10a formed on the surface of the frame 10 and the holes of the slicing blade 20. Additionally, the fastening method is not intended to be limited by the method using bolts, as long as the slicing blade 20 can be secured onto the frame 10.

The exchange blade 50 is attached between the slicing blade 20 and the movable supporting plate 40. The exchange blade 50 has its two ends supported by the frame 10. The exchange blade 50 is provided with a plurality of teeth formed on the exchange blade 50 in the longitudinal direction, and used for forming notches on the material to be sliced along the slicing direction S in accordance with the gap of the teeth. The exchange blade 50 is pressed onto the frame 10 and secured thereto by bolts, not shown, that are inserted from bolt through holes 10c formed on the outer side face 10b of the frame 10. By using the slicing blade 20 and the exchange blade 50 in combination with each other, the material to be slice can be sliced into stick shapes or rectangular strip shapes having various sizes.

The movable supporting plate 40 and the slice width adjusting dial 60 are freely detachably attached to the frame 10 so that the respective members can be washed individually.

The slicer 1 is provided with an anti-slipping member 100 to be described later that is attached to the tip thereof in the slicing direction S.

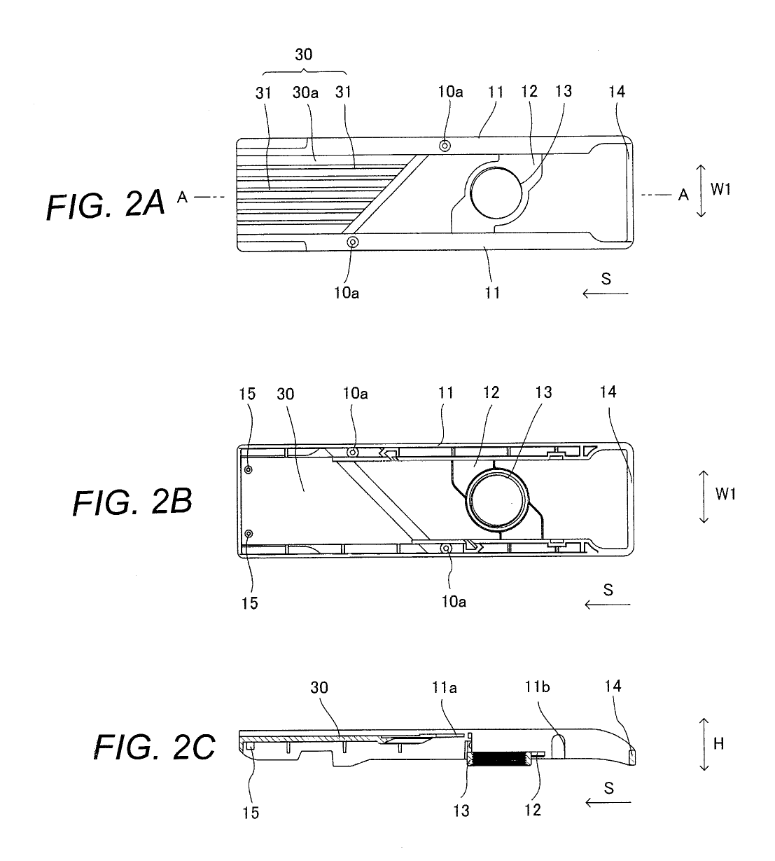

As shown in FIGS. 2A to 2C, the frame 10 is provided with a pair of right and left supporting arms 11 attached to the two ends in the width direction of the fixed supporting plate 30, a stay 12 passed between the paired right and left supporting arms 11 and a screw receiving hole 13 that can be meshed with a slice width adjusting dial to be described later that is formed substantially in the center of the stay 12.

The supporting arms 11 are provided with slits 11a that are formed on the inner side faces, and used for housing the two ends of the slicing blade 20. The slicing blade 20 is inserted through the slits 11a and disposed at a predetermined position.

Each of the supporting arms 11 is provided with a guide groove 11b that is formed on the inner side face as a concave portion. The guide groove 11b is extended along the vertical direction H. The guide groove 11b is meshed with a pin 41 to be guided, which will be described later, of the movable supporting plate 40. Additionally, the shape of the guide groove 11b may be desirably formed. Since the lower portion in the vertical direction H of the guide groove 11b is formed as an opening, the movable supporting plate 40 is attachably detached from the frame 10.

The frame 10 is provided with a grip 14 to be held by the user. In the present embodiment, the grip 14 is integrally joined to the rear end of the supporting arm 11; however, the grip 14 may have a structure to be detachably fastened thereto with bolts, as long as it can be secured to the supporting frame 10.

Moreover, on the frame 10, bolt holes 15 through which by inserting bolts, not shown, the anti-slipping member 100 to be described later is secured onto the rear surface 30a of the fixed supporting plate 30 are formed.

The fixed supporting plate 30 is disposed between the paired supporting arms 11, and integrally attached to the supporting arms 11. On the surface 30b of the fixed supporting plate 30, 6 rows of groove portions 31 are engraved and formed side by side in the width W1 direction in a manner so as to be extended in the slicing direction S. However, the number of rows of the groove portions 31 is not limited by 6. By forming the groove portions 31 on the surface 30b of the fixed supporting plate 30, the fixed supporting plate 30 and the material to be sliced are made in contact with each other with a reduced contact area so that the material to be sliced can be smoothly moved reciprocally. The depth dimension of the groove portions 31 may be desirably determined.

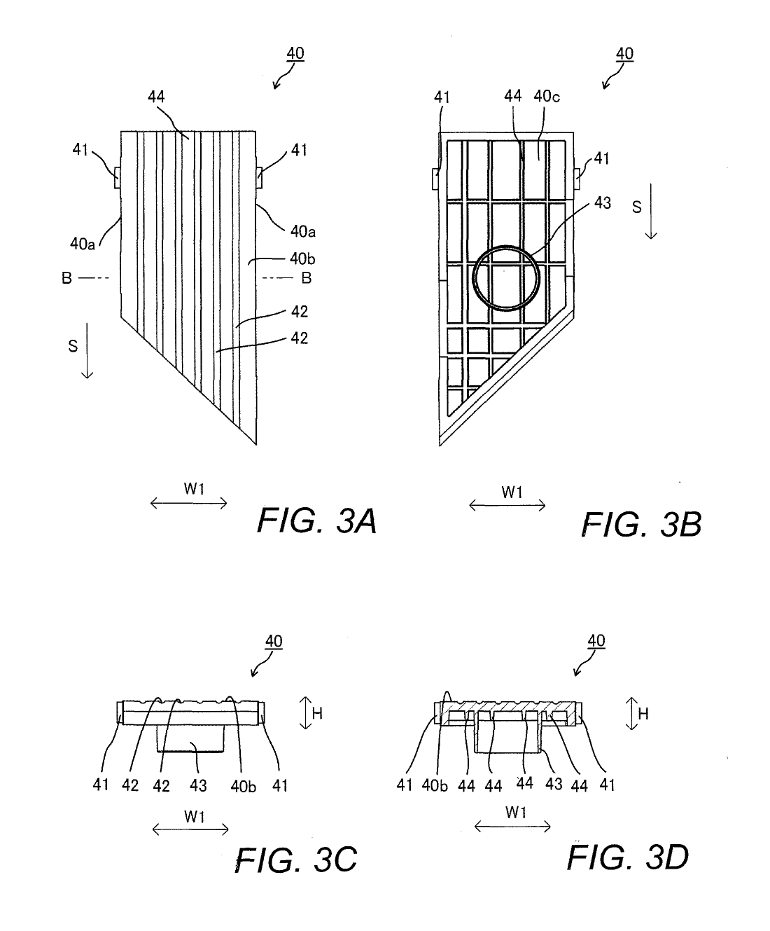

As shown in FIGS. 3A to 3D, the movable supporting plate 40 is provided with the pin 41 to be guided that is formed so as to stand on the rear side of the side face 40a. The pin 41 to be guided is designed to be engaged with the guide groove 11b of the supporting arm 11 so that the movable supporting plate 40 is raised/lowered in accordance with the shape of the guide groove 11b. For example, in the case when the guide groove 11b is formed from the lower side to the upper side in the vertical direction H, as well as diagonally from the rear side toward the front side in the slicing direction S, the movable supporting plate 40 is also raised/lowered up and down in accordance with the shape of the guide groove 11b. When the movable supporting plate 40 is raised, the pin 41 to be guided is engaged with the guide groove 11b so that wobbling or twisting of the movable supporting plate 40 is regulated.

The movable supporting plate 40 is provided with 6 rows of groove portions 42 that are formed on the surface 40b side by side in the width direction W1 in a manner so as to extend in the slicing direction S. However, the number of the rows of the groove portions 42 is not intended to be limited by 6. By forming the groove portions 42, the contact area between the movable supporting plate 40 and the material to be sliced is reduced correspondingly so that the sliding resistance at the time of slicing the material to be sliced can be reduced.

On the rear surface 40c of the movable supporting plate 40, a first rib 43 formed into a hollow cylindrical shape and a second rib 44 disposed in a lattice pattern are installed. By forming the first rib 43 and the second rib 44, the rigidity of the movable supporting plate 40 is increased.

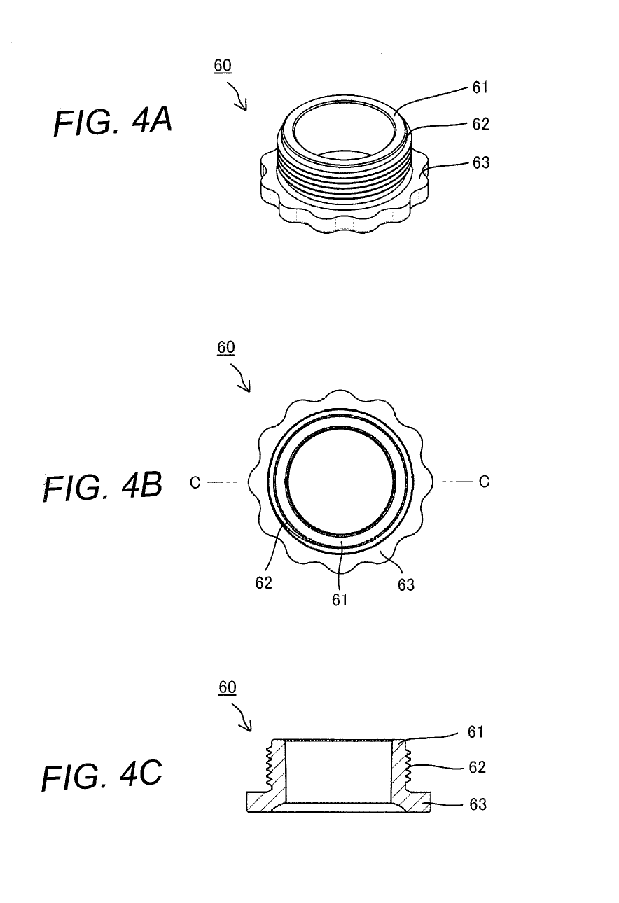

As shown in FIG. 4A to 4C, the slice width adjusting dial 60 is provided with a main body unit 61 having a hollow cylindrical shape, a screw portion 62 formed on the outer peripheral surface of the main body unit 61 and a handle 63 formed on the base end of the main body unit 61.

The inner diameter of the main body unit 61 is formed larger than the outer diameter of the first rib 43.

The screw portion 62 can be meshed with the screw receiving hole 13.

The handle 63 is grabbed when the user rotates the slice width adjusting dial 60 so as to vertically raise/lower the movable supporting plate 40.

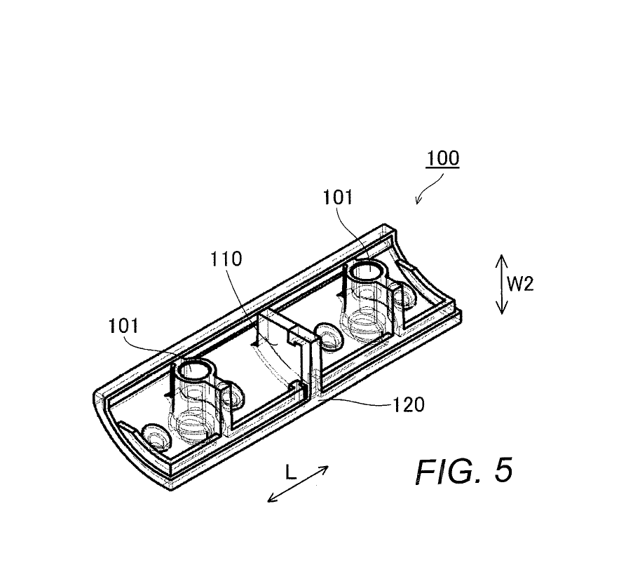

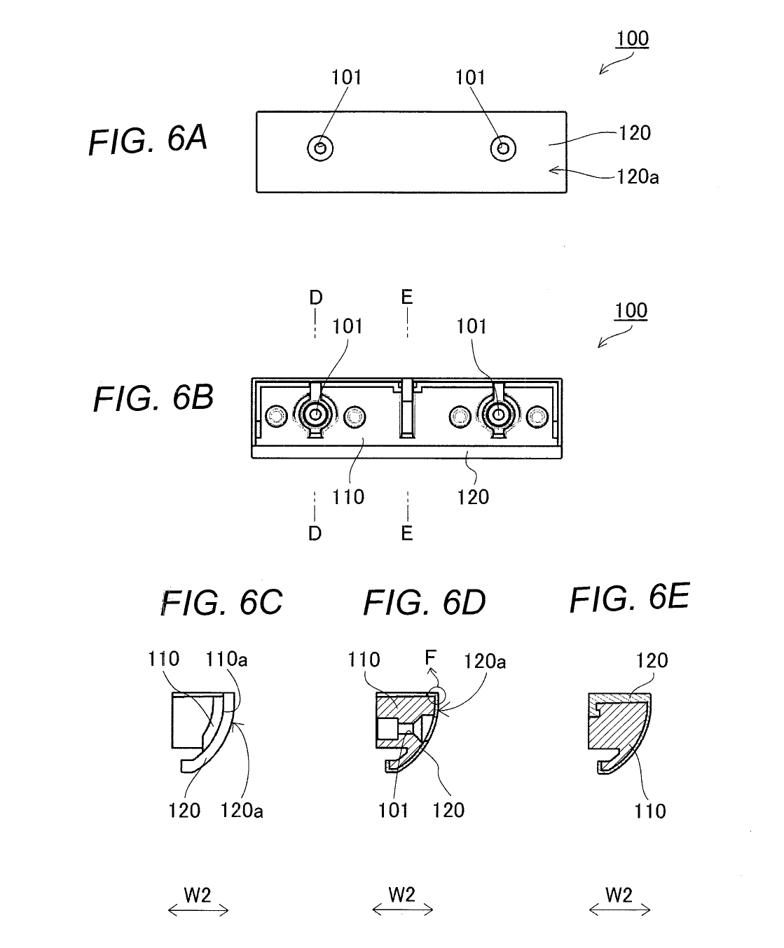

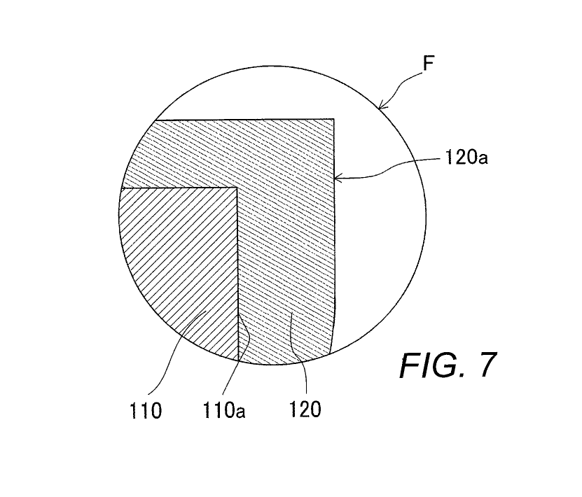

Next, referring to FIGS. 5 to 7, the following description will explain the anti-slipping member 100.

The anti-slipping member 100 is provided with a bolt hole 101, and by meshing a bolt, not shown, with the bolt hole 15 of the frame 10, while inserted through the bolt hole 101, the anti-slipping member 100 is attached to the frame 10. Thus, the anti-slipping member 100 can be desirably detachably attached to the frame 10 on demand by the user.

The anti-slipping member 100 is formed by expanding an elastomer resin over the surface thereof. More specifically, the anti-slipping member 100 is provided with a base portion 110 that is made of polypropylene, and detachably attached onto a rear surface 30b of the fixed supporting plate 30, and an elastomer portion 120 formed by fixing an elastomer resin onto the surface 110a of the base portion 110. However, the anti-slipping member 100 is not necessarily limited by the elastomer resin, but any resin may be used as long as it exerts an anti-slipping effect similar to that of the elastomer resin.

The anti-slipping member 100 is formed with its cross-sectional shape in a width direction W2 perpendicular to the longitudinal direction L being curved into an arc shape. With this structure, even in the case when the user uses the slicer 1 in a tilted state relative to a chopping board or the like, since the elastomer portion 120 increases the frictional resistance between the slicer 1 and the chopping board or the like, the slicer 1 is stabilized without being slipped so that it is possible to safely slice the material to be sliced.

The elastomer portion 120 is formed by spraying the elastomer resin over the surface 110a of the base portion 110. Additionally, as a specific method for fixing the elastomer resin onto the base portion 110, any method may be used as long as the elastomer resin can be fixed onto the base portion 110, and although the method for spraying the elastomer resin over the base portion 110 provides superior adhesiveness, it is not limited only by this method.

The elastomer portion 120 is formed on the entire surface of the surface 110a of the base portion 110. Thus, the contact area between the elastomer portion 120 and chopping board is ensured, and the frictional resistance between the slicer 1 and the chopping board or the like is further increased.

In this manner, in the slicer 1 in accordance with the present embodiment, even in the case when the slicer 1 is diagonally pressed onto a chopping board or the like, since the anti-slipping portion 100 increases the frictional resistance between the slicer 1 and the chopping board or the like, it becomes possible to prevent so-called slipping, that is, a phenomenon in which the slicer 1 slips on the chopping board or the like, so that the tilted attitude of the slicer 1 can be stabilized and the slicer 1 can be used safely.

Additionally, in the present invention, various modifications may be made within the scope without departing from the gist of the present invention, and those modifications are of course included within the scope of the present invention.
1 SLICER
10 FRAME
10a ATTACHING HOLE
10b OUTER SIDE FACE
10b BOLT COMMUNICATION HOLE
11 SUPPORTING ARM
11a SLIT
11b GUIDE GROOVE
12 STAY
13 SCREW RECEIVING HOLE
14 GRIP
15 BOLT HOLE (OF FRAME)
20 SLICING BLADE
30 FIXED SUPPORTING PLATE
30a REAR SURFACE (OF FIXED SUPPORTING PLATE)
30b SURFACE (OF FIXED SUPPORTING PLATE)
31 GROOVE PORTION (OF FIXED SUPPORTING PLATE)
40 MOVABLE SUPPORTING PLATE
40a SIDE FACE
40b SURFACE (OF MOVABLE SUPPORTING PLATE)
40c REAR SURFACE (OF MOVABLE SUPPORTING PLATE)
41 PIN TO be GUIDED
42 GROOVE PORTION (OF MOVABLE SUPPORTING PLATE)
43 FIRST RIB
44 SECOND RIB
50 EXCHANGE BLADE
60 SLICE WIDTH ADJUSTING DIAL
61 MAIN BODY PORTION
61a TOP SURFACE
62 SCREW PORTION
63 HANDLE
70 SLICE WIDTH ADJUSTING MECHANISM
100 ANTI-SLIPPING MEMBER
101 BOLT HOLE (OF ANTI-SLIPPING MEMBER)
110 BASE PORTION
110a SURFACE (OF BASE PORTION)
120 ELASTOMER PORTION
120a SURFACE (OF ELASTOMER PORTION)
B1 BOLT
H VERTICAL DIRECTION
L LONGITUDINAL DIRECTION (OF ANTI-SLIPPING MEMBER)
S SLICING DIRECTION
W1 WIDTH DIRECTION (OF SLICER)
W2 WIDTH DIRECTION (OF ANTI-SLIPPING MEMBER)

What is claimed is:

1. A slicer comprising:
a frame having a pair of supporting arms; and a slicing blade with two ends thereof being supported by the paired supporting arms, so that by reciprocally moving a material to be sliced in a slicing direction toward the slicing blade, the material to be sliced is sliced,
wherein an anti-slipping member, which is disposed under the frame at a tip end thereof in the slicing direction, is further prepared.

2. The slicer according to claim 1, wherein the anti-slipping member comprises:
a base portion that is disposed on a rear surface of the frame and made of polypropylene; and an elastomer portion formed by fixing an elastomer resin on the surface of the base portion.

3. The slicer according to claim 2, wherein the elastomer portion is formed by spraying the elastomer resin onto the surface of the base portion.

4. The slicer according to claim 2, wherein the elastomer portion is formed over the entire surface of the base portion.

5. The slicer according to claim 2, wherein the elastomer portion is formed into a curved convex shape with the surface thereof facing the outside.
